(19) United States
(12) Patent Application Publication
(10) Pub. No.: US 2025/0322558 A1
(43) Pub. Date: Oct. 16, 2025

(54) SYSTEM FOR ESTABLISHING AN IMAGE ANALYSIS MODEL AND DATA AUGMENTATION METHOD THEREOF

(71) Applicant: VIA TECHNOLOGIES, INC., New Taipei City (TW)

(72) Inventors: Ting WANG, Beijing (CN); Li FANG, Beijing (CN); Ziye ZHOU, Beijing (CN); Jiao LI, Beijing (CN); Chao-Chin CHANG, New Taipei City (TW)

(21) Appl. No.: 19/018,388

(22) Filed: Jan. 13, 2025

(30) Foreign Application Priority Data
Apr. 15, 2024 (CN) 202410451930.2

(51) Int. Cl. G06T 11/00; G06V 10/774

(52) U.S. Cl. CPC G06T 11/00; G06T 2210/21; G06V 10/774

(57) ABSTRACT

A data augmentation method for establishing an image analysis model is provided, including the first step and the second step. The first step includes inputting a set of control conditions into an image generation model to obtain a generated image that is generated by the image generation mode based on the control conditions. The set of control conditions includes a template image and control text, where the control text contains a first prompt associated with a specific scene. The second step includes composing a generated sample with the generated image and label data that correspond to the template image. The method further includes selectively excluding generated samples based on a set of filtering conditions and adding the remaining generated samples to the training dataset for establishing the analysis model.

### CROSS REFERENCE TO RELATED APPLICATIONS

This Application claims priority of China Patent Application No. 202410451930.2, filed on Apr. 15, 2024, the entirety of which is incorporated by reference herein.

### BACKGROUND OF THE INVENTION

### Field of the Invention

The present invention relates to machine learning techniques, and, in particular, to a system for establishing an image analysis model and data augmentation thereof.

### Description of the Related Art

The application of autonomous driving can involve various types of machine learning models, such as object detection models, object recognition models, and distance/depth estimation models. The establishment of these models requires a large number of labeled sample images as training data. However, in certain specific scenes, such as low-visibility scenes or scenes containing rare target objects, suitable sample images are often lacking, leading to performance issues of the models in these specific scenes.

In terms of low visibility scenes, this includes nighttime scenarios such as nighttime photography, scenes with limited light sources (e.g., in underground parking lots, tunnels, or dense shade), and scenes with special weather conditions (e.g., dense fog, rainstorms, snowstorms, sandstorms, or haze). The images themselves are unclear, and the boundaries of targets are indistinct, resulting in high annotation costs, fewer samples, and difficulties in ensuring label accuracy. A conventional approach employs some image processing techniques, such as noise reduction, blur reduction, and brightness enhancement, to first make the images clearer or at least closer to normal scenes, and then input the processed images into the model. However, this approach requires significant computational resources and time, making it difficult to meet the real-time demands of autonomous driving in a cost-effective manner.

In those scenes containing rare target objects, such as traffic cones, guardrails, forklifts, and road rollers, it may be difficult to collect sufficient sample images of these objects on roads for training models. As a result, their proportion in the model's training dataset is very low, which leads to poor detection or recognition performance for these target objects. Typical approaches apply oversampling or undersampling to adjust the proportion of sample images containing rare target objects in the training dataset, or employ image processing techniques to replicate rare targets within the same sample images. However, the aforementioned approaches may introduce an excessive number of homogenous samples or features, leading to overfitting in the model, which could potentially interfere with or hinder the model's ability to learn the characteristics of other target objects.

For overcoming the aforementioned drawbacks, conventional approaches may apply Generative Adversarial Networks (GANs) to generate additional sample images with similar features to those of specific scenes, thereby increasing the sample size for these scenes. However, this approach still faces some challenges. For example, in addition to the unstable performance and difficulty in training convergence of the generative adversarial network itself, the lack or imbalance in the authenticity and diversity of the samples may make the model more insensitive to the distribution of various data in real environment, limiting its adaptability. Additionally, the generated sample images need to undergo denoising and/or edge-smoothing processing to make them closer to real scenes, and it is not feasible to skip this step and immediately generate a large number of usable sample images. Due to the nature of GANs, even with adjustments made to the internal structure of the network or various related hyperparameters, it is still difficult to avoid the aforementioned problems.

In summary, conventional approaches usually face issues such as high implementation costs, inflexible control conditions, and/or the generation of unrealistic samples. Furthermore, those aforementioned traditional approaches do not involve how to automatically eliminate sample images that cannot meet the requirements of real-world application scenarios. Therefore, there is a need for a system and method for establishing image analysis models that can address these issues.

### BRIEF SUMMARY OF THE INVENTION

An embodiment of the present disclosure provides a system for establishing an image analysis model, including a processing unit and a storage unit. The processing unit to execute a sample generation process, a sample filtering process, and a model establishment process loaded from the storage unit. The sample generation process includes the steps of inputting a set of control conditions into an image generation model to obtain a generated image that is generated by the image generation model based on the control conditions, and composing the generated sample with label data corresponding to a template image and the generated image. The sample generation process selectively eliminates generated samples based on a set of filtering conditions and adds those remaining generated samples after selective eliminations into the training dataset used to establish the image analysis model. The model establishment process includes establishing the image analysis model using the training dataset.

An embodiment of the present disclosure provides a data augmentation method for establishing an image analysis model implemented by a computer system. The method includes inputting a set of control conditions into an image generation model to obtain the generated image from the image generation model based on the control conditions. The method further includes composing a generated sample with label data corresponding to the template image and the generated image. Additionally, the method further includes selectively eliminating the generated samples based on a set of filtering conditions and adding the remaining generated samples after selective eliminations into the training dataset used for establishing the image analysis model.

The system and data augmentation method disclosed herein for establishing an image analysis model enable the generation of diverse, realistic, and quality-assured generated samples at lower implementation costs and with more flexible control conditions. This enhances the adaptability and overall performance of the image analysis model across various real-world scenarios.

### BRIEF DESCRIPTION OF THE DRAWINGS

The present invention can be more fully understood by reading the subsequent detailed description and examples with references made to the accompanying drawings, wherein:

FIG. 1 is a hardware architecture diagram of a system for establishing an image analysis model, according to an embodiment of the present disclosure;

FIG. 2 illustrates a software architecture diagram of a system for establishing an image analysis model, according to an embodiment of the present disclosure;

FIG. 3 is a flow diagram of a data augmentation method, according to an embodiment of the present disclosure;

FIG. 4 illustrates an example of a first embodiment of the present disclosure, in which the generated image is generated by the image generation model based on the template image and the control text.

FIG. 5 illustrates an example of a second embodiment of the present disclosure, where the generated image is generated by the image generation model based on the template image, control text, and specified region parameter set;

FIG. 6A illustrates an example of a third embodiment of the present disclosure, where the generated image is generated by the image generation model based on the template image, control text, and specified region parameter set;

FIG. 6B illustrates another example of the third embodiment of the present disclosure, where the second specified region parameter set and the third specified region parameter set are used in combination as control conditions;

FIG. 7 illustrates an example of the fourth embodiment of the present disclosure, where the generated image is generated by the image generation model based on the template image and the control text;

FIG. 8 illustrates an example of the fifth embodiment of the present disclosure, where the generated image is generated through the image generation model based on the template image, control text, and region parameter set;

FIG. 9 illustrates a flow diagram of more detailed steps of selectively eliminating the generated samples based on a set of filtering conditions, according to an embodiment of the present disclosure;

FIG. 10 illustrates a flow diagram of more detailed steps of selectively eliminating the generated samples based on a set of filtering conditions, according to another embodiment of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

In each of the following embodiments, the same reference numbers represent identical or similar components or assemblies.

Ordinal terms used in the claims, such as “first,” “second,” “third,” etc., are only for convenience of explanation, and do not imply any precedence relation between one another.

The descriptions for embodiments of devices or systems in this specification also apply to embodiments of methods, and vice versa.

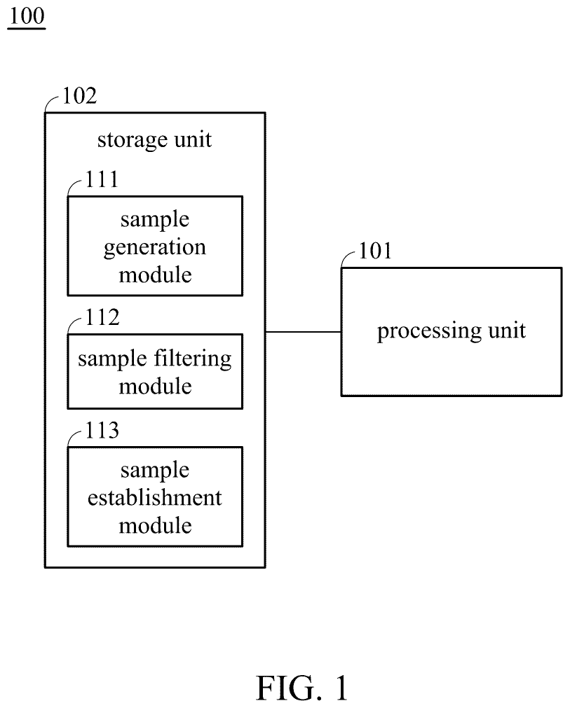

FIG. 1 is a hardware architecture diagram of a system 100 for establishing an image analysis model, according to an embodiment of the present disclosure. As shown in FIG. 1, the system 100 may include interconnected processing unit 101 and storage unit 102, where the storage unit stores one or more programs corresponding to sample generation module 111, sample filtering module 112, and model establishment module 113.

The system 100 may be any computing system with processing capabilities, such as personal computers (e.g., desktop or laptop computers), server computers, or mobile devices such as tablets or smartphones, but the present disclosure is not limited thereto.

The processing unit 101 may include one or more general-purpose or specialized processors and the combination thereof for executing instructions. In a typical embodiment, the processing unit may include a Central Processing Unit (CPU) and a Graphics Processing Unit (GPU), where the GPU is more efficient than the CPU in processing tasks related to machine learning. Therefore, tasks may be allocated based on the characteristics of the CPU and GPU, such as assigning tasks related to obtaining image data or communicating with other devices to the CPU, while tasks related to image generation and model training are assigned to the GPU. In a further embodiment, the processing unit 101 may also include a Neural Processing Unit (NPU) optimized for deep learning tasks. Compared to the GPU, the NPU may have computational advantages in operating deep neural networks, so that those tasks related to deep neural networks may be assigned to the NPU.

The storage unit 102 may be any device containing non-volatile memory such as Read-Only Memory (ROM), Electrically-Erasable Programmable Read-Only Memory (EEPROM), Flash memory, or Non-Volatile Random Access Memory (NVRAM), including devices such as Hard Disk Drives (HDDs), Solid State Drives (SSDs), or optical discs, but the present disclosure is not limited thereto. In various embodiments, the storage unit 102 is used to store one or more programs corresponding to the sample generation module 111, sample filtering module 112, and model establishment module 113. Programs consist of a sequence or a set of instructions for the computer system to execute. In various embodiments, programs may be written in any programming language such as Java, C, C #, C++, or Python, but the present disclosure is not limited thereto. When the processing unit 101 loads programs from the storage unit 102, it may execute the sample generation module 111, sample filtering module 112, and model establishment module 113, which respectively correspond to the sample generation process, sample generation process, and model establishment process. In other words, when the processing unit 101 loads programs from the storage unit 102, it may execute the sample generation process, sample generation process, and model establishment process, which will be further described later. Furthermore, the storage unit 102 may also be used to store various data required or generated by the methods disclosed herein, such as template images, label data, generated images, and training datasets, which will be described in more detail later.

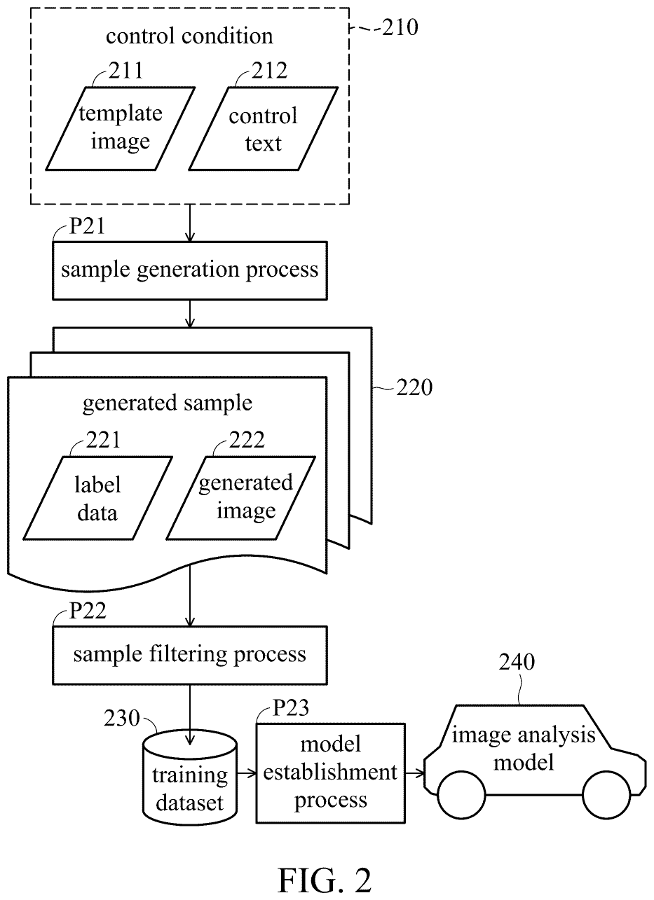

FIG. 2 illustrates a software architecture diagram of a system 100 for establishing an image analysis model, according to an embodiment of the present disclosure. As shown in FIG. 2, from a software perspective, the system 100 may include sample generation process P21, sample filtering process P22, and model establishment process P23.

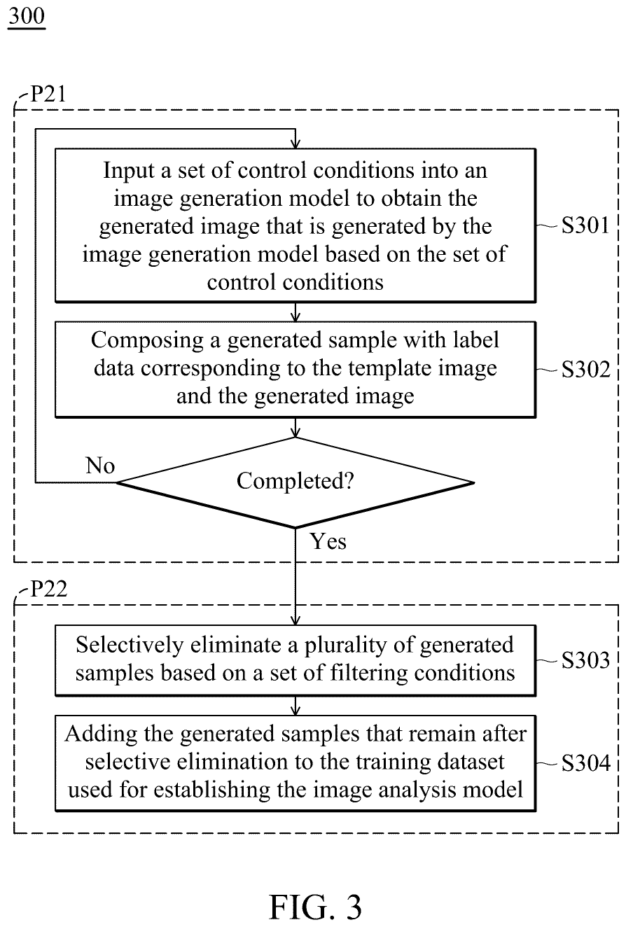

In general, the sample generation process P21 receives a set of control conditions 210 encompassing a template image 211 and a control text 212, and outputs the generated sample 220 encompassing label data 221 and a generated image. Subsequently, the sample filtering process P22 filters a plurality of the generated samples 220 generated by the sample generation process P21 to eliminate those that do not meet the requirements of practical application scenarios. The remaining generated samples 220 are then incorporated into the training dataset 230 and used to establish an image analysis model 240 through the model establishment process P23. Further details regarding the steps of the sample generation process P21 and the sample filtering process P22 will be provided in reference to FIG. 3. However, before proceeding to FIG. 3, an explanation will be provided regarding the model development process P23 and the image analysis model 240.

One of the primary applications of the image analysis model 240 is in autonomous driving. In this specification, “autonomous driving” is not limited to “fully autonomous driving” but may encompass various levels of autonomous driving. Specifically, reference may be made to the widely cited levels of automated driving defined by the Society of Automotive Engineers International (SAE International) in the J3016 standard, which outlines six levels of automated driving, as shown in the following <Table 1>.

TABLE 1

| | | | Driving | | Fallback | |
|---|---|---|---|---|---|---|
| Level | Name | Definition | control | Monitoring | responsibility | Application |
| L0 | Manual | The vehicle is | Human | Driver | Driver | N/A |
| | Driving | entirely driven by a | driver | | | |
| | | human driver. | | | | |
| L1 | Driver | The vehicle provides | Driver and | | | Limited |
| | Assistance | driving assistance | system | | | |
| | | for either steering or | | | | |
| | | acceleration/braking, | | | | |
| | | while the human | | | | |
| | | driver is responsible | | | | |
| | | for the rest of the | | | | |
| | | driving tasks. | | | | |
| L2 | Partial | The system provides | System | | | |
| | Automation | driving assistance | | | | |
| | | for vehicle both | | | | |
| | | steering and | | | | |
| | | acceleration/braking, | | | | |
| | | while the human | | | | |
| | | driver is responsible | | | | |
| | | for the rest of the | | | | |
| | | driving tasks. | | | | |
| L3 | Conditional | The system performs | | System | | |
| | Automation | most of driving | | | | |
| | | tasks, but the human | | | | |
| | | driver must remain | | | | |
| | | alert and ready to | | | | |
| | | take over if needed. | | | | |
| L4 | High | All driving | | | System | |
| | Automation | operations are | | | | |
| | | performed by the | | | | |
| | | system, and the | | | | |
| | | human driver does | | | | |
| | | not need to remain | | | | |
| | | alert, but it is limited | | | | |
| | | to specific roadways | | | | |
| | | and environmental | | | | |
| | | conditions. | | | | |
| L5 | Full | The system handles | | | | All |
| | Automation | all driving tasks and | | | | scenarios |
| | | the human driver | | | | |
| | | does not need to | | | | |
| | | remain alert. | | | | |

In this specification, “autonomous driving” encompasses levels L1 to L5 as outlined in <Table 1>.

The image analysis model 240 may be any machine learning model used in autonomous driving applications (such as those mentioned in Table 1, levels L1 to L5), further including object detection models, object recognition models, or distance (or depth) estimation models. These models use image data delivered by sensors or cameras mounted on vehicles as input to perform tasks related to environment perception. Object detection models are used to detect and locate various objects on the road, such as vehicles, pedestrians, and obstacles, to assist vehicle drivers in planning optimal driving paths, obstacle avoidance, and enhancing driving safety. The object recognition models further improve environmental understanding by not only detecting the presence of objects but also classifying them to support decision-making. For example, the object recognition models may be used to identify the type of vehicles approaching from behind, such as ambulances, fire trucks, or regular vehicles; the color of traffic lights, such as red, yellow, or green; various traffic signs, such as no parking, no entry, road construction signs; and road surface markings, such as lane lines or crosswalks. The distance estimation models are used to estimate the distance or depth between the vehicle and surrounding objects to support decision-making in tasks such as adaptive cruise control (maintaining a proper distance from the vehicle ahead) and automatic parking (avoiding collisions with surrounding vehicles or walls).

In addition to autonomous driving applications, the image analysis model 240 may be used for various image-based monitoring applications. For example, chemical plants, oil and gas processing facilities, power plants, biopharmaceutical factories, and other industrial facilities require monitoring for leaks of toxic or flammable gases, smoke, or liquids. However, due to the scarcity of such samples and the difficulty in collecting them, there are fewer samples available for training, resulting in lower model accuracy. To overcome the limitation of model performance due to the limited number of samples, the sample generation process P21 may be used to generate relevant samples. These samples may then be processed through the sample filtering process P22 and the model establishment process P23 to establish the image analysis model 240 for performing the aforementioned monitoring tasks.

The machine learning algorithms used by the model establishment process P23 for establishing the image analysis model 240 depends on the type of task assigned to the model. For example, when the image analysis model 240 is an object detection model, the model establishment process P23 may adopt algorithms such as Faster R-CNN, YOLO (You Only Look Once), SSD (Single Shot MultiBox Detector), FPN (Feature Pyramid Networks), along with appropriate loss functions and optimizers, to implement the training of the image analysis model 240. Similarly, when the image analysis model 240 is an object recognition model, the model establishment process P23 may adopt convolutional neural networks (CNN) to implement a feature extractor and implement a classifier using decision trees, logistic regression, naive Bayes, random forest, Support Vector Machine (SVM), or fully connected neural networks. Additionally, loss functions that are commonly used for classifications, such as cross-entropy, contrastive loss, hinge loss, or KL divergence, may be used to measure the difference between predicted values and actual values, and determine the direction of parameter optimization during model training. When the image analysis model 240 is a distance estimation model, the model establishment process P23 may adopt algorithms such as convolutional neural networks, multilayer perceptrons (MLP), recurrent neural networks (RNN), or convolutional recurrent neural networks (CRNN). Those loss functions commonly used for regressions, such as Mean Squared Error (MSE), Mean Absolute Error (MAE), Huber Loss, or Log-Cosh Loss, may be used to measure the difference between predicted values and actual values. Various forms of gradient descent, such as Stochastic Gradient Descent (SGD) or Adaptive Moment Estimation (Adam), may then be used to compute gradients and update weights through backpropagation to minimize the loss value. It should be noted that the descriptions above regarding the model establishment process P23 are merely examples to illustrate the implementation aspects of the present disclosure and are not for limiting purpose.

FIG. 3 is a flow diagram illustrating a data augmentation method 300, according to an embodiment of the present disclosure. The method 300 may be implemented by the system 100 depicted in FIG. 1. As shown in FIG. 3, the method 300 includes the sample generation process P21 and the sample screening process P22 from FIG. 2. The sample generation process P21 further includes steps S301 and S302, while the sample screening process P22 further includes steps S303 and S304. Please refer to both the FIGS. 2 and 3 together for a better understanding of the embodiments.

In step S301 of the sample generation process P21, a set of control conditions 210 is input into the image generation model to obtain the generated image 222 that is generated by the image generation model based on the set of control conditions 210. As shown in FIG. 2, the control conditions 210 may include template images 211 and control texts 212.

In step S302 of the sample generation process P21, the generated sample 220 is composed with the generated image 222 and the label data 221 corresponding to the template image 211.

The sample generation process P21 may repeat steps S301 and S302 using a lot of sets of control conditions to obtain a plurality of generated samples 220. In other words, steps S301 and S302 are executed repeatedly with different sets of control conditions 210 until all sets of control conditions 210 have been processed, resulting in a plurality of generated samples 220 that comply with their respective control conditions. Subsequently, the sample filtering process P22 is performed.

In step S303 of the sample filtering process P22, generated samples 220 are selectively eliminated based on a set of filtering conditions. In other words, those in the generated samples 220 that do not meet the criteria of this set of filtering conditions are eliminated.

In step S304 of the sample filtering process P22, those remaining generated samples 220 after selective eliminations are added into the training dataset 230 used for establishing the image analysis model 240. Subsequently, the image analysis model 240 may be derived through the model establishment process P23.

The aforementioned image generation model may be any type of text-to-image model that incorporates a language model into its architecture. Therefore, it can take natural language descriptions as input control conditions and generate images that match those control conditions. The image generation model may be trained by developers using a dataset composed of a large number of image-text pairs collected by themselves, or may be directly adopted from established and publicly available models. The acquisition of the image generation model is not limited by the present disclosure.

In an embodiment, the image generation model may be selected from Stable Diffusion, ControlNet, GLIGEN, and/or any combination thereof. Stable Diffusion is a variation of a diffusion model called the “latent diffusion model” (LDM), which supports the use of text prompts to describe elements to include or omit in generating new images or re-drawing existing ones. The functionality used in this embodiment is to redraw existing images, which Stable Diffusion accomplishes through its diffusion-denoising mechanism by incorporating new elements described in the text prompts, a process also known as “guided image synthesis.” ControlNet is a plug-in for Stable Diffusion that provides additional control conditions, allowing for more precise controls over details such as the pose, depth of field, and textures of people or objects in the image. GLIGEN establishes upon pre-trained text-to-image diffusion models by adding supports for grounded inputs, enabling image generations based on grounded language. For example, GLIGEN may generate target contents according to text definitions by specifying the location of the targets in the images using masks, contours, or bounding boxes.

The template image 211 serves as the basis for image generation and represents a normal scene. Developers may collect the template image themselves or obtain it from open datasets like Pascal VOC or COCO (Common Objects in Context). Either the source or acquisition of the template image 211 is not limited by the present disclosure. Additionally, collected template images 211 are labelled, thus possessing corresponding label data 221, even though they are not explicitly drawn adjacent to each other in FIG. 2. The pattern of label data 221 depends on the task type of the image analysis model 240. For instance, when the image analysis model 240 is an object detection model, the label data 221 includes position and extent information of objects in the template image 211, usually represented by bounding boxes. When the image analysis model 240 is an object recognition model, the label data 221 represents the category of objects themselves or their signaling cues in the image. For example, in the case of a vehicle behind, it might be an ambulance, a fire truck, or a general vehicle. Similarly, for traffic lights, it might be red, yellow, or green. When the image analysis model 240 is a distance estimation model, the label data 221 represents the actual distance between the camera and the objects in the template image 211.

The control text 212 may be in any natural language, such as Chinese, English, Spanish, etc., used to control or guide how the image generation model produces the generated image 222 based on the template image 211. In various embodiments disclosed herein, the control text 212 contains prompt text associated with a specific scene, and the generated image 222 has relevant features of that specific scene based on the prompt text. To distinguish various prompt text that may be used in different embodiments disclosed herein, the prompt text associated with specific scenes are referred to as “first prompt.” The language model component in the image generation model may detect the first prompt from the control text 212 and convert them into latent representations. Subsequently, the generator in the image generation model may generate the content that matches the description provided in the control text 212 based on the latent representations. Therefore, given the same template image 211 and different control text 212, the sample generation process P21 may output different generated images 222, while these generated images 222 share the same label data 221.

The generated sample 220 obtained through the sample generation process P21 directly inherit the label data 221 from the template image 211. This not only saves the time and cost associated with manual annotation but also ensures the accuracy and authenticity of the labels. Consequently, the subsequent image analysis model 240 built on this basis performs better in specific scenes.

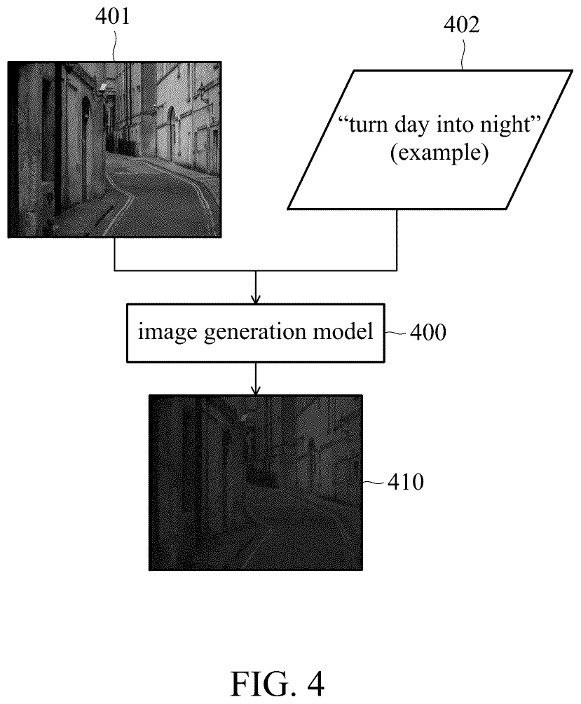

The following will refer to FIG. 4 to FIG. 8 to illustrate embodiments of various control conditions producing various generated images.

FIG. 4 illustrates an example of a first embodiment of the present disclosure, in which the generated image 410 is generated by the image generation model 400 based on the template image 401 and the control text 402.

The control text 402 includes a first prompt associated with a specific scene, and the generated image 410 exhibits certain features of that scenario. In the first embodiment, the specific scene pertains to low visibility conditions, thus the generated image 410 exhibits visibility-related features of low visibility scenarios. In the example of FIG. 4, the content of the control text 402, “turn day into night,” contains a first prompt “night” associated with nighttime scenes. Therefore, the generated image 410 exhibits visibility-related features of nighttime scenes, such as low brightness and dark hues. But other than that, the positions of various objects in the generated image 410 remain unchanged relative to the template image 401, allowing for the direct use of the labels from the template image 401.

It's worth noting that the template image 401, control text 402, and generated image 410 in FIG. 4 are provided as examples, not limitations of the present disclosure. Particularly regarding the control text 402, its sentence structure and/or terminology in the example content can be modified. For instance, it could be modified to “change to a nighttime scene,” or the first prompt “night” could be replaced with synonyms like “evening” or “nighttime.” As long as the semantics are essentially the same as the example “turn day into night,” the image generation model 400 can translate various appropriate variations of the control text 402 into the same latent representation, thus producing generated images 410 with the same visual effect.

Additionally, while the example in FIG. 4 illustrates a nighttime scene, in the first embodiment, the specific scene may also be replaced by other factors causing low visibility, such as underground parking lots, tunnels, dense tree shade with limited light sources, as well as special weather conditions like dense fog, rainstorms, snowstorms, dust storms, or haze. Therefore, in the first embodiment, the first prompt could be “underground parking lot,” “tunnel,” “tree shade,” “dense fog,” “rainstorms,” “snowstorm,” “dust storm,” “haze,” or synonyms of these terms.

In an embodiment, each set of control conditions may further include intensity parameters associated with low visibility scenarios. The intensity parameter may be a numerical value specified within a range (e.g., [0, 1], [1, 10], or [1, 100]), indicating the degree of poor visibility. For example, a larger value of the intensity parameter indicates a greater change in visibility relative to the template image, resulting in lower visibility.

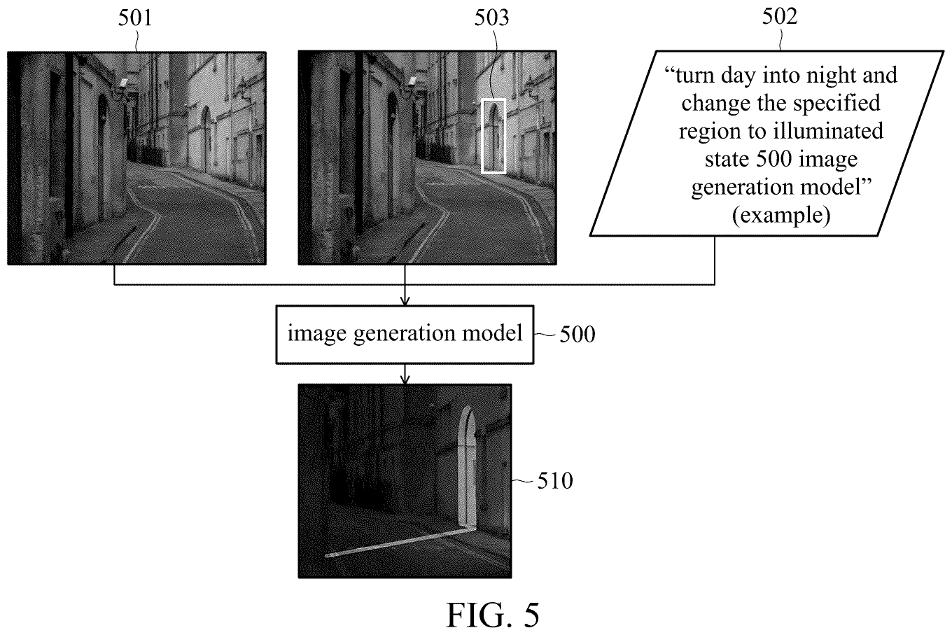

FIG. 5 illustrates an example of a second embodiment of the present disclosure, which the generated image 510 is generated by the image generation model 500 based on the template image 501, control text 502, and a specified region parameter set 503. To distinguish between various sets of specified region parameters that may be used in different embodiments disclosed herein, the set of specified region parameters 503 used in the second embodiment is referred to as the “second specified region parameter set” with its corresponding prompt set termed the “second prompt set.”

The second specified region parameter set 503 is also included in the control conditions to specify particular regions in the template image 501 for configuration by the image generation model 500 to conform to the content described in the control text 502. In the second embodiment, the specific scene is also a low-visibility scene, so the generated image 510 also exhibits visibility-related features characteristic of low-visibility scenes. Additionally, compared to the control text 402 in the first embodiment, the control text 502 in the second embodiment includes the second prompt set corresponding to the second specified region parameter set 503. The second prompt set is associated with the combination of the region indicated by the second specified region parameter set 503, hereinafter referred to as the “second specified region”, and the lighting effects, thereby rendering lighting effects to the second specified region in the generated image 510. In the example of FIG. 5, the content of the control text 502, “turn day into night and change the specified region to illuminated state”, contains the first prompt “night” associated with the nighttime scene, and the second prompt set “specified region” and “illuminated” associated with the specified region indicated by the second specified region parameter set 503 and lighting effects. Consequently, the generated image 510 exhibits visibility-related features of nighttime scenes, such as low brightness and dark hues, and also features lighting effects in the second specified region. However, apart from these changes, the positions of various objects in the generated image 510 remain unchanged relative to the template image 501, allowing for the direct use of the labels from the template image 501.

Similar to the description of FIG. 4 earlier, the example content of the control text 502 may be modified in terms of sentence structure and/or terminology. For instance, it could be modified to “transform into nighttime scenes and illuminate the specified region” or change the term “specified region” in the second prompt set to a synonym like “enclosed area”, and change the term “illuminate” to a synonym like “light up.” As long as the essence of the semantics remains unchanged, the image generation model 500 can translate various appropriate variations of the control text 502 into the same latent representation, thereby producing generated images 510 with the same visual effects. Additionally, the specific scene can also be replaced with other factors causing low-visibility scenarios, such as limited light source scenes like underground parking lots, tunnels, dense tree shade, and special weather conditions like dense fog, rainstorms, snowstorms, sandstorms, or haze.

The second specified region parameter set may be any form of representation used to denote regions of interest (ROI) in the image. In an embodiment, the second specified region parameter set may be selected from masks, edges, and bounding boxes, among others.

Masking techniques involve assigning a binary index value to each pixel in an image, such that pixels within the region of interest (e.g., the second specified region) have an index value of “1”, while pixels outside the region of interest have an index value of “0”; or conversely, pixels within the region of interest have an index value of “0”, while pixels outside the region of interest have an index value of “1”. This allows for the identification and processing of the region of interest based on the index values provided by the mask.

Edges are transition regions between different areas in an image, typically representing the contours of objects or areas of significant change. In terms of specific data structures, edges may be represented as a series of connected points or pixels forming a curve or a collection of curves to reflect the shape of regions in the image. In implementations, edges are often stored in the form of vectors, sequences of coordinate points, or similar data structures.

A bounding box is a rectangular frame that exactly encloses the objects or regions of interest in an image and may be represented in various ways. For example, when the second specified region parameter set is a bounding box, it may be composed of the coordinates of any vertex of the bounding box plus the length and width of the bounding box. It may also be composed of the coordinates of all vertices of the bounding box (i.e., the upper-left vertex, the lower-left vertex, the upper-right vertex, and the lower-right vertex), or it may be composed of the coordinates of two points on the diagonal (e.g., the combination of the upper-left vertex and the lower-right vertex, or the combination of the lower-left vertex and the upper-right vertex), but the present disclosure is not limited thereto.

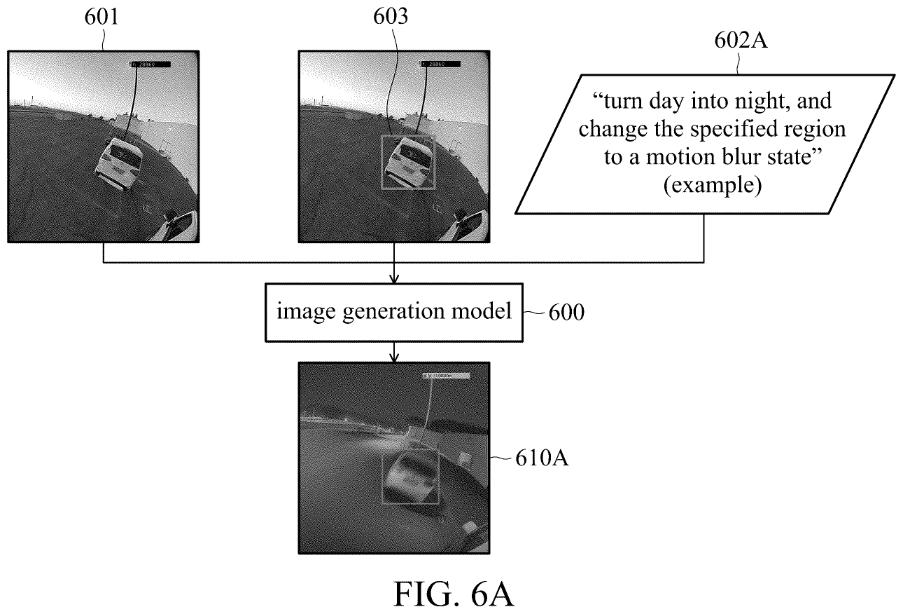

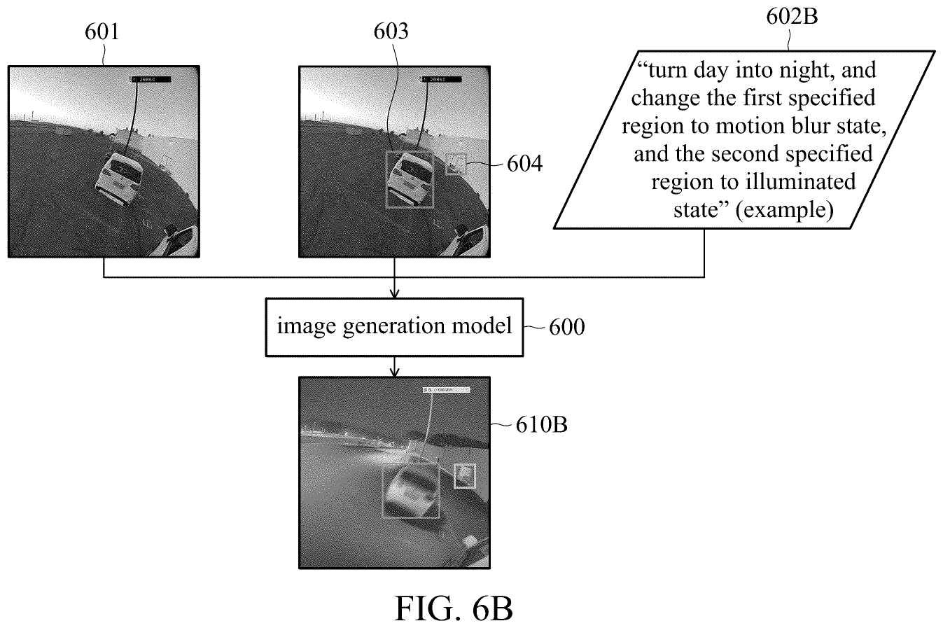

FIG. 6A illustrates an example of the third embodiment of the present disclosure, which the generated image 610A is generated by the image generation model 600 based on the template image 601, control text 602A, and specified region parameter set 603. To distinguish between the various specified region parameter sets that may be used in the embodiments disclosed herein, the specified region parameter set 603 used in the third embodiment is referred to as the “third specified region parameter set,” and its corresponding prompt set is referred to as the “third prompt set.”

The third specified region parameter set 603 is also included in the control conditions to specify specific regions in the template image 601 for the image generation model to configure in accordance with the content described in the control text 602A. In the third embodiment, the specific scene is also a low visibility scene, so the generated image 610A also has visibility-related features of a low visibility scene. Additionally, compared to the control text 402 in the first embodiment, the control text 602A in the third embodiment further includes a third prompt set corresponding to the third specified region parameter set 603. The third prompt set is associated with the combination of the region indicated by the third specified region parameter set 603, hereinafter referred to as the “third specified region”, and the motion blur effect, enabling the generated image 610A to have a motion blur effect in the third specified region. In the example of FIG. 6A, the content of the control text 602A “turn day into night, and change the specified region to a motion blur state” includes the first prompt “night” associated with the nighttime scene and the third prompt set associated with the third specified region parameter set 603, “specified region” and “motion blur,” indicating the motion blur effect in the third specified region. Therefore, the generated image 610A has visibility-related features of a nighttime scene, such as low brightness and dark hues, and has a motion blur effect in the third specified region. However, in addition to these changes, the positions of various objects in the generated image 610A relative to the template image 601 remain unchanged, allowing for the direct use of the labels from the template image 601.

As with the descriptions of FIGS. 4 and 5, the example content of the control text 602A may be modified in terms of sentence structure and/or terminology. For example, it could be modified to “change to nighttime scene and apply motion blur to the specified region,” alternatively the term “specified region” in the third prompt set could be replaced with a synonym like “enclosed region,” and “motion blur” could be replaced with a synonym like “dynamic blur.” As long as the essence of the semantics remains unchanged, the image generation model 600 may translate various appropriate changes to the control text 602A into the same latent representation, resulting in generated images 610A with the same visual effects. Additionally, the specific scene may be replaced by other factors resulting in low visibility scenes, such as limited light source scenes like underground parking lots, tunnels, dense tree shade, as well as special weather conditions like dense fog, rainstorms, snowstorms, dust storms, or haze.

Like the second specified region parameter set, the third specified region parameter set may also be any form of representation used to indicate regions of interest in the image. In an embodiment, the third specified region parameter set may also be selected from masks, edges, and bounding boxes as previously introduced, and will not be reiterated here.

FIG. 6B illustrates another example of the third embodiment of the present disclosure, where the aforementioned second specified region parameter set and third specified region parameter set are used in combination as control conditions. In other words, the control conditions of the image generation model 600 simultaneously include the third specified region parameter set 603 and the second specified region parameter set 604. Therefore, the generated image 610B is generated by the image generation model 600 based on the template image 601, control text 602B, third specified region parameter set 603, and second specified region parameter set 604. In this example, the content of the control text 602B is “turn day into night, and change the first specified region to motion blur state, and the second specified region to illuminated state,” where “night” is the first prompt associated with nighttime scenes; “the first specified region” is a pronoun representing the third specified region indicated by the third specified region parameter set 603, forming the third prompt set along with the term “motion blur”; “the second specified region” is a pronoun representing the second specified region indicated by the second specified region parameter set 604, forming the second prompt set along with the term “illuminated ”. Therefore, the generated image 610 not only has motion blur effects in the third specified region indicated by the third specified region parameter set 603 but also has lighting effects in the second specified region indicated by the second specified region parameter set 604.

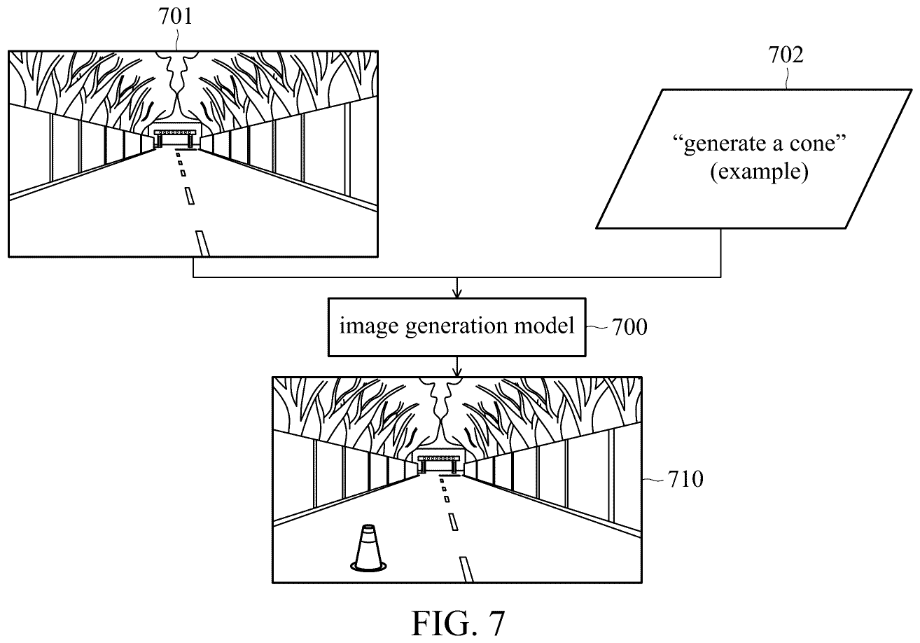

FIG. 7 illustrates an example of the fourth embodiment of the present disclosure, where the generated image 710 is generated by the image generation model 700 based on the template image 701 and the control text 702.

In the fourth embodiment, the specific scene includes the presence of rare target objects. Correspondingly, the first prompt in the control text is not only related to the specific scene but also to the rare target objects within it. Therefore, the generated image will contain the rare target object. In the example of FIG. 7, the content of control text 702 “generate a traffic cone” contains the first prompt “cone,” which is associated with the rare target object. Therefore, the generated image 710 contains a traffic cone. Since the generated image 710 adds a traffic cone relative to the template image 701, the corresponding label data of the generated image 710 may also include labels corresponding to the traffic cone (optionally), such as the position of the traffic cone in the image. As for other objects in the image, their position distribution remains unchanged, so the labels from the template image 701 can be directly used, such as the position of the lane lines in the image.

As previously mentioned, the syntactic structure and/or terminology of the example content in control text 702 can be modified. For example, it can be changed to “add a traffic cone,” or the first prompt “traffic cone” can be replaced with synonyms like “road cone.” As long as the semantic essence remains unchanged, the image generation model 700 can translate various appropriate variations of control text 702 into the same latent representation, thereby producing generated images 710 with the same visual effects. Additionally, the rare target objects may be replaced with other less common items on the road, such as bollards, guardrails, forklifts, road rollers, road maintenance signs, or potentially hazardous substances like toxic or flammable gases, smoke, or liquids that may leak from chemical plants, oil and gas processing plants, power plants, biopharmaceutical factories, etc., but the present disclosure is not limited thereto.

In a variation of the fourth embodiment, control text 702 may further include a posture prompt associated with the rare target object, causing the rare target object in generated image 710 to exhibit the pose indicated by the posture prompt. For example, in the example of FIG. 7, the content of control text 702 may be replaced with “generate a fallen cone,” causing the traffic cone in generated image 710 to appear in a fallen pose.

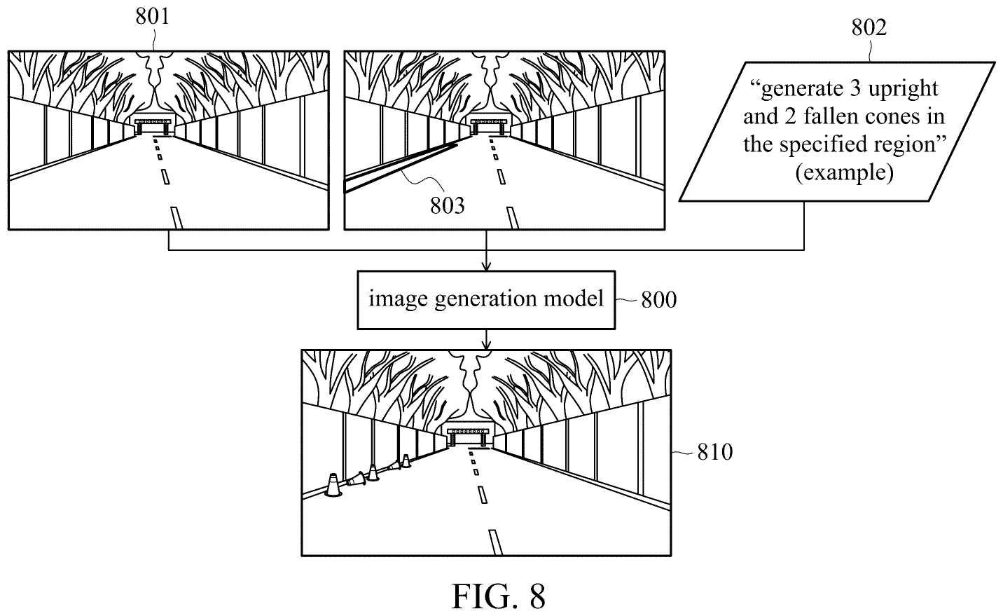

FIG. 8 illustrates an example of a fifth embodiment of the present disclosure, where the generated image 810 is generated through the image generation model 800 based on the template image 801, control text 802, and region parameter set 803. To distinguish between the various region parameter sets that may be used in the embodiments disclosed herein, the region parameter set 803 used in the fifth embodiment is referred to as the “fourth region parameter set,” and its corresponding prompt are referred to as the “fourth prompt.”

In the fifth embodiment, the control conditions may further include the fourth region parameter set 803 corresponding to the rare target object, used to specify the specific region in the template image 801 for configuration by the image generation model 800 to conform to the content described in the control text 802. Furthermore, compared to the control text 702 in the fourth embodiment, the control text 802 in the fifth embodiment further includes the fourth prompt associated with the fourth specified region indicated by the fourth region parameter set 803. Therefore, the generated image 810 contains a rare target object in the fourth specified region.

In a variation of the fifth embodiment, the control text 802 may further include a quantity prompt associated with the rare target object, allowing the generated image 810 to contain the quantity of rare target objects indicated by the quantity prompts in the fourth specified region indicated by the fourth region parameter set 803. Furthermore, the control text 802 may also include the posture prompt mentioned earlier. The various combinations of quantity prompts and posture prompts can lead to multiple variations in the generated image 810.

In the example of FIG. 8, the content of control text 802 “generate 3 upright and 2 fallen cones in the specified region” contains the first prompt “cone” associated with the rare target object, the fourth prompt “specified region” associated with the fourth specified region indicated by the fourth specified region parameter set 803, and the combination of quantity prompt and posture prompt (“3”, “upright”) and (“2”, “fallen”) associated with the rare target object. Therefore, the generated image 810 contains 3 upright and 2 fallen cones in the fourth specified region indicated by the fourth specified region parameter set 803.

As previously described for FIG. 7, the syntax structure and/or terminology of control text 802 can be modified. For example, it can be changed to “generate 5 traffic cones in the specified region, with 3 standing and 2 toppled,” or the first prompt “traffic cone” can be replaced with synonyms such as “road cone”, the fourth prompt “specified region” can be replaced with synonyms like “enclosed region,” and the posture prompts “standing” and “toppled” can be respectively changed to “upright” and “fallen.” Additionally, the quantity prompts in Arabic numerals “3” and “2” can be replaced with words “three” and “two.” As long as the essence remains unchanged, the image generation model 800 can translate various appropriate changes in control text 802 into the same latent representation, resulting in the same visual effect for generating image 810. Moreover, the rare target object may be replaced with other objects that are relatively rare on the road, such as bollards, guardrails, forklifts, road rollers, road maintenance signs, or with hazardous substances like toxic or flammable gases, smoke, or liquids that may leak from chemical plants, oil and gas processing plants, power plants, biopharmaceutical plants, etc., but the present disclosure is not limited thereto.

Similar to the second specified region parameter set and the third specified region parameter set, the fourth specified region parameter set can also be any representation used to mark the region of interest in the image. In an embodiment, the fourth specified region parameter set may also be selected from the previously introduced masks, edges, bounding boxes, etc., and will not be reiterated here.

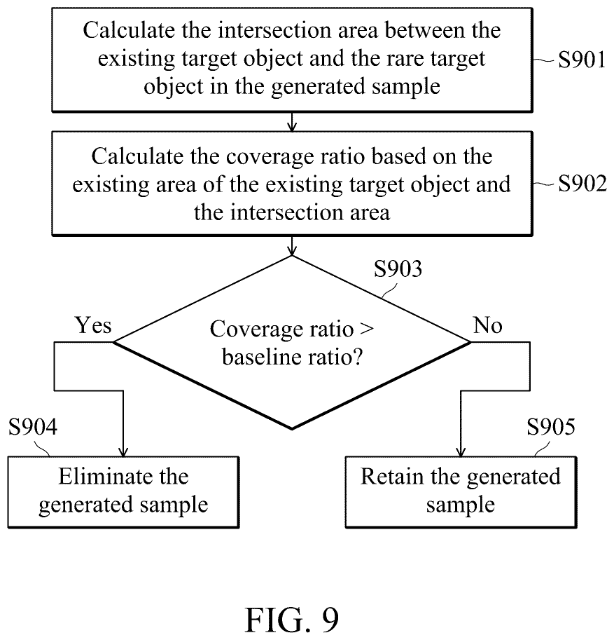

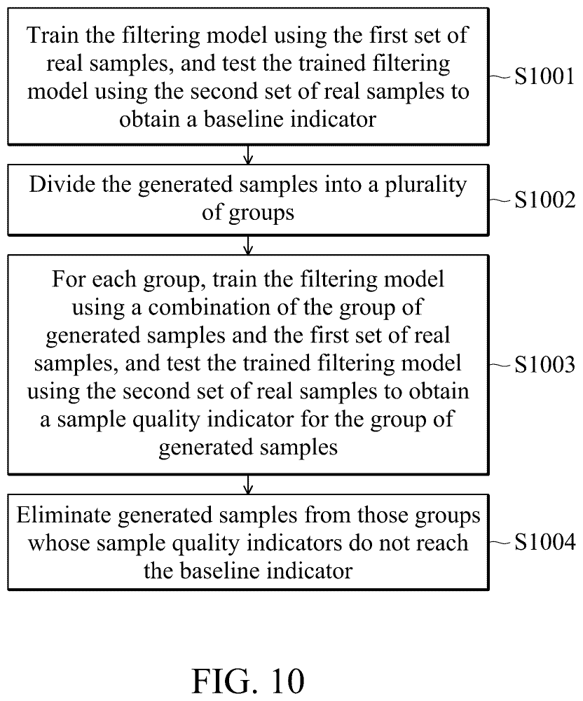

The above-described first, second, third, fourth, and fifth embodiments, along with their various modifications, which produce different generated images based on different control conditions, can be combined and/or alternately applied to generate a diverse set of generated samples. Next, further embodiments of the sample filtering process P22 will be described with reference to FIG. 9 and FIG. 10.

FIG. 9 illustrates the flow diagram of more detailed steps of step S303 from FIG. 3, according to an embodiment of the present disclosure. As shown in FIG. 9, step S303 may further include steps S901 to S905. These steps are executed for each of a plurality of generated samples containing rare target objects, and therefore, they are repeated multiple times until all generated samples containing rare target objects have been filtered.

In step S901, the intersection area between existing target objects and rare target objects in the generated samples is calculated. The existing target objects refer to the objects originally present in the template image, typically the focus of attention for image analysis models. Although the shape, size, and distribution of existing target objects remain unchanged in the generated images, certain generated images (such as the generated images 710 in FIG. 7 and 810 in FIG. 8) may have rare target objects that partially occlude existing target objects. Therefore, step S901 is equivalent to calculating how much area of the existing target objects is covered by the generated rare target objects.

In step S902, the coverage ratio is calculated based on the existing area of the existing target object and the intersection area. For example, if the existing area of the existing target object is 10 units and the intersection area is 2 units, then the coverage ratio is calculated by dividing the intersection area by the existing area, which is 2/10=20%. Therefore, step S902 is equivalent to calculating what proportion of the existing target object's area is covered by the generated rare target objects.

In step S903, whether to eliminate the generated sample is determined by comparing the coverage ratio with a baseline ratio, which serves as a specified threshold. The value of the baseline ratio may depend on the size of the existing target object. For example, if the existing target object is small, the baseline ratio may be set to 30%; if it is large, the baseline ratio may be set to 70%, but the present disclosure is not limited thereto. If the coverage ratio exceeds the baseline ratio, it indicates that the existing target object is excessively occluded by the generated rare target objects, which may lead to significant loss of key features of the existing target object and consequently impact the detection or recognition of the existing target object by the image analysis model. Therefore, in step S904, such generated sample is eliminated. Conversely, if the coverage ratio does not exceed the baseline ratio, it indicates that the occlusion of the existing target object by the generated rare target objects is within a reasonable range. In this case, step S905 is performed, where the generated sample is retained.

FIG. 10 illustrates the flow diagram of more detailed steps of step S303 from FIG. 3, according to another embodiment of the present disclosure. As shown in FIG. 10, step S303 can further include steps S1001 to S1004.

In general, the method used in the embodiment of FIG. 10 includes training the filtering model by mixing generated samples with real samples to evaluate the generated samples. The principle is that well-generated samples mixed with real samples should further improve the performance of the model, while poorly generated samples may degrade the model's performance. Here, the term “real samples” refers to real images of normal scenes and their corresponding label data. The template images and their corresponding label data mentioned earlier may be selected from real sample datasets. The filtering model shares the same task type as the image analysis model (such as object detection, object recognition, or distance estimation), conceptually serving as a pre-simulation version of the image analysis model for evaluating generated samples. The performance of the model may be measured using various common machine learning model evaluation metrics, such as accuracy, precision, recall, F1-score, area under the receiver operating characteristic curve (ROC-AUC), etc., but the present disclosure is not limited thereto.

In step S1001, the filtering model is trained using the first set of real samples, and then the trained filtering model is tested using the second set of real samples to obtain a baseline metric. For instance, there is a batch of 1500 real samples, where 1000 are used as the first set of real samples to train the filtering model, and the remaining 500 are used as the second set of real samples to test the filtering model trained on the first set of 1000 real samples, a baseline metric (such as accuracy, precision, recall, F1-score, or ROC-AUC) denoted as M0 is obtained.

In step S1002, the generated samples are divided into multiple groups. The number of groups is not limited by the present disclosure. For example, the 1000 generated samples may be evenly divided into 10 groups, each containing 100 generated samples.

In step S1003, for each group, the combined generated samples and the first set of real samples are used to train the filtering model, and the filtering model trained with this combination is tested using the second set of real samples to obtain a quality indicator for the generated samples in that group. For example, the 100 generated samples from the first group are mixed with the 1000 real samples from the first set to train the filtering model. After training, the model is tested with the 500 real samples from the second set, resulting in the quality indicator M1 for the generated samples in the first group. Similarly, the 100 generated samples from the second group are mixed with the 1000 real samples from the first set to train the filtering model. After training, the model is tested with the 500 real samples from the second set, resulting in the quality indicator M2 for the generated samples in the second group. This process is repeated for the remaining 8 groups, resulting in quality indicators M3 to M10 for each group's generated samples, respectively.

In step S1004, the generated samples from groups whose quality indicators do not reach a baseline indicator are eliminated. Then, the process returns to step S1002 and repeats steps S1002 to S1004 to perform a more refined filtering of the remaining generated samples until the quality indicators for all groups exceed the baseline indicator. For instance, if M1, M4, and M9 among M1 to M10 are lower than M0, it indicates that the qualities of the generated samples from the first, fourth, and ninth groups are poor, so they are eliminated. The remaining 700 generated samples from the 7 groups are then equally divided into 5 groups, each containing 140 generated samples. The 140 generated samples from the first group are mixed with the same 1000 real samples from the first set to train the filtering model. After training, the model is tested with the 500 real samples from the second set, resulting in the quality indicator MM1 for the generated samples in the first group. Similarly, the 140 generated samples from the first group are mixed with the 1000 real samples from the first set to train the filtering model. After training, the model is tested with the 500 real samples from the second set, resulting in the quality indicator MM2 for the generated samples in the second group. This process is repeated for the remaining 3 groups, resulting in quality indicators MM3 to MM5 for each group of generated samples, respectively. Next, MM1 to MM5 are compared with M0 one by one. If it is found that MM1 to MM5 are all greater than M0, it means that the qualities of the generated samples from these five groups meet the level conducive to improving the model performance, and thus they can be added to the training dataset for establishing the image analysis model.

It should be appreciated that the two sample filtering methods illustrated in FIG. 9 and FIG. 10 may be used independently or in combination. Additionally, the samples that are eliminated may be selectively retrieved as training data for the image analysis model based on specific needs, but the present disclosure is not limited thereto.

The system and data augmentation method disclosed herein for establishing an image analysis model enable the generation of diverse, realistic, and quality-assured generated samples at lower implementation costs and with more flexible control conditions. This enhances the adaptability and overall performance of the image analysis model across various real-world scenarios.

The above paragraphs are described with multiple aspects. Obviously, the teachings of the specification may be performed in multiple ways. Any specific structure or function disclosed in examples is only a representative situation. According to the teachings of the specification, it should be noted by those skilled in the art that any aspect disclosed may be performed individually, or that more than two aspects could be combined and performed.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for establishing an image analysis model, comprising a processing unit and a storage unit, wherein the processing unit loads a program from the storage unit to execute a sample generation process, a sample filtering process, and a model establishment process;
wherein the sample generation process comprises:
inputting a set of control conditions into an image generation model to obtain a generated image that is generated by the image generation model based on the set of control conditions, wherein the set of control conditions comprises a template image and a control text, and the control text comprises a first prompt associated with a specific scene; and
composing a generated sample with label data corresponding to the template image and the generated image;
wherein the sample filtering process comprises:
selectively eliminating a plurality of generated samples based on a set of filtering conditions; and
adding the generated samples that remain after selective elimination to a training dataset used for establishing the image analysis model;
wherein the model establishment process comprises:
establishing the image analysis model using the training dataset.

2. The system as claimed in claim 1, wherein the specific scene is a low-visibility scene; and
wherein the generated image possesses visibility-related features of the low-visibility scene.

3. The system as claimed in claim 1, wherein the set of control conditions further comprises a second specified region parameter set;
wherein the control text further comprises a second prompt set corresponding to the second specified region parameter set;
wherein the second prompt set is associated with a combination of a second specified region indicated by the second specified region parameter set and a lighting effect; and
wherein the generated image that is generated based on the set of control conditions possesses the lighting effect in the second specified region.

4. The system as claimed in claim 1, wherein the set of control conditions further comprises a third specified region parameter set;
wherein the control text further comprises a third prompt set corresponding to the third specified region parameter set;
wherein the third prompt set is associated with a combination of a third specified region indicated by the third specified region parameter set and a motion blur effect; and
wherein the generated image that is generated based on the set of control conditions possesses the motion blur effect in the third specified region.

5. The system as claimed in claim 1, wherein the specific scene includes a rare target object, and the first prompt is further associated with the rare target object; and
wherein the generated image contains the rare target object.

6. The system as claimed in claim 5, wherein the set of control conditions further comprises a fourth specified region parameter set corresponding to the rare target object;
wherein the control text further comprises a fourth prompt associated with a fourth specified region indicated by the fourth specified region parameter set; and
wherein the rare target object in the generated image that is generated based on the set of control conditions is located in the fourth specified region.

7. The system as claimed in claim 6, wherein the control text further comprises a quantity prompt associated with the rare target object; and
wherein the generated image in the fourth specified region contains the quantity of rare target objects indicated by the quantity prompt.

8. The system as claimed in claim 5, wherein the control text further comprises a posture prompt associated with the rare target object; and
wherein the rare target object in the generated image presents a posture indicated by the posture prompt.

9. The system as claimed in claim 5, wherein the set of filtering conditions comprises an existing target object and a corresponding baseline ratio; and
wherein the sample filtering process further comprises following operations for each generated sample:
calculating an intersection area between the existing target object and the rare target object in the generated sample;
calculating a coverage ratio based on an existing area of the existing target object and the intersection area; and
determining whether to eliminate the generated sample by comparing the coverage ratio and the baseline ratio.

10. The system as claimed in claim 1, wherein the set of filtering conditions comprises a first set of real samples, a second set of real samples, and a filtering model; and
wherein the sample filtering process further comprises:
training the filtering model using the first set of real samples, and testing the trained filtering model using the second set of real samples to obtain a baseline indicator;
dividing the generated samples into a plurality of groups;
for each group, training the filtering model using a combination of the group of generated samples and the first set of real samples, and testing the trained filtering model using the second set of real samples to obtain a sample quality indicator for the group of generated samples; and
eliminating generated samples from those groups whose sample quality indicators do not reach the baseline indicator.

11. A data augmentation method for establishing an image analysis model, implemented by a computer system, the method comprising:
inputting a set of control conditions into an image generation model to obtain a generated image that is generated by the image generation model based on the set of control conditions, wherein the set of control conditions comprises a template image and a control text, and the control text comprises a first prompt associated with a specific scene;
composing a generated sample with label data corresponding to the template image and the generated image;
selectively eliminating the generated samples based on a set of filtering conditions; and
adding the generated samples that remain after selective elimination to a training dataset used for establishing the image analysis model.

12. The method as claimed in claim 11, wherein the specific scene is a low-visibility scene; and
wherein the generated image possesses visibility-related features of the low-visibility scene.

13. The method as claimed in claim 12, wherein the set of control conditions further comprises a second specified region parameter set;
wherein the control text further comprises a second prompt set corresponding to the second specified region parameter set;
wherein the second prompt set is associated with a combination of a second specified region indicated by the second specified region parameter set and a lighting effect; and
wherein the generated image that is generated based on the set of control conditions possesses the lighting effect in the second specified region.

14. The method as claimed in claim 11, wherein the set of control conditions further comprises a third specified region parameter set;
wherein the control text further comprises a third prompt set corresponding to the third specified region parameter set;
wherein the third prompt set is associated with a combination of a third specified region indicated by the third specified region parameter set and a motion blur effect; and
wherein the generated image that is generated based on the set of control conditions possesses the motion blur effect in the third specified region.

15. The method as claimed in claim 11, wherein the specific scene contains a rare target object, and the first prompt is further associated with the rare target object; and
wherein the generated image contains the rare target object.

16. The method as claimed in claim 15, wherein the set of control conditions further comprises a fourth specified region parameter set corresponding to the rare target object;
wherein the control text further comprises a fourth prompt associated with a fourth specified region indicated by the fourth specified region parameter set; and
wherein the rare target object in the generated image that is generated based on the set of control conditions is located in the fourth specified region.

17. The method as claimed in claim 16, wherein the control text further comprises a quantity prompt associated with the rare target object; and
wherein the generated image in the fourth specified region includes the quantity of rare target objects indicated by the quantity prompt.

18. The method as claimed in claim 15, wherein the control text further comprises a posture prompt associated with the rare target object; and
wherein the rare target object in the generated image presents a posture indicated by the posture prompt.

19. The method as claimed in claim 15, wherein the set of filtering conditions comprises an existing target object and a corresponding baseline ratio; and
wherein the step of selectively eliminating the generated samples based on the set of filtering conditions further comprises following operations for each generated sample:
calculating an intersection area between the existing target object and the rare target object in the generated sample;
calculating a coverage ratio based on an existing area of the existing target object and the intersection area; and
determining whether to eliminate the generated sample by comparing the coverage ratio and the baseline ratio.

20. The method as claimed in claim 11, wherein the set of filtering conditions comprises a first set of real samples, a second set of real samples, and a filtering model; and
wherein the step of selectively eliminating the generated samples based on the set of filtering conditions further comprises:
training the filtering model using the first set of real samples, and testing the trained filtering model using the second set of real samples to obtain a baseline indicator;
dividing the generated samples into multiple groups;
for each group, training the filtering model using a combination of the group of generated samples and the first set of real samples, and testing the trained filtering model using the second set of real samples to obtain a sample quality indicator for the group of generated samples; and
eliminating generated samples from those groups whose sample quality indicators do not reach the baseline indicator.
